(19) United States
(12) Patent Application Publication
(10) Pub. No.: US 2024/0232708 A1
(43) Pub. Date: Jul. 11, 2024

(54) MODEL TRAINING USING FEDERATED LEARNING

(71) Applicant: Lenovo (Singapore) Pte. Ltd., New Tech Park (SG)

(72) Inventors: Dimitrios Karampatsis, Ruislip (GB); Ishan Vaishnavi, München (DE)

(21) Appl. No.: 18/290,603

(22) PCT Filed: Aug. 24, 2021
(86) PCT No.: PCT/EP2021/073416

§ 371 Date: Jan. 19, 2024

(30) Foreign Application Priority Data
Jul. 20, 2021 (GR) 20210100488

(51) Int. Cl. G06N 20/00

(52) U.S. Cl. CPC G06N 20/00

(57) ABSTRACT

Apparatuses, methods, and systems are disclosed for model training using federated learning. One method includes receiving a first request from a network function which includes requirements to derive an aggregated trained model using federated learning from a local model training logical function. The method includes determining model parameters for aggregation using federated learning based on the requirements in the first request. The method includes discovering a local model training logical function that can provide model parameters for aggregation using federated learning based on the requirements. The method includes transmitting a second request to the local model training logical function to receive the model parameters. The method includes aggregating the model parameters using federated learning. The method includes transmitting a response including the aggregated model parameters.

### FIELD

The subject matter disclosed herein relates generally to wireless communications and more particularly relates to model training using federated learning.

### BACKGROUND

In certain wireless communications networks, models may require training. The training needed for the models may be inefficient.

### BRIEF SUMMARY

Methods for model training using federated learning are disclosed. Apparatuses and systems also perform the functions of the methods. One embodiment of a method includes receiving, at a model training logical function that supports aggregation of model parameters using federated learning, a first request from a network function. The first request includes first requirements to derive an aggregated trained model using federated learning from at least one local model training logical function. In some embodiments, the method includes determining model parameters for aggregation using federated learning based on the first requirements in the first request. In certain embodiments, the method includes discovering at least one local model training logical function that can provide model parameters for aggregation using federated learning based on the first requirements. In various embodiments, the method includes transmitting a second request to the at least one local model training logical function to receive the model parameters for deriving the aggregated trained model. In some embodiments, the method includes aggregating the model parameters using federated learning. In certain embodiments, the method includes transmitting a response to the first request. The response includes the aggregated model parameters.

One apparatus for model training using federated learning includes a model training logical function. In some embodiments, the apparatus includes a receiver that receives a first request from a network function. The model training logical function supports aggregation of model parameters using federated learning, and the first request includes first requirements to derive an aggregated trained model using federated learning from at least one local model training logical function. In various embodiments, the apparatus includes a processor that: determines model parameters for aggregation using federated learning based on the first requirements in the first request; and discovers at least one local model training logical function that can provide model parameters for aggregation using federated learning based on the first requirements. In certain embodiments, the apparatus includes a transmitter that transmits a second request to the at least one local model training logical function to receive the model parameters for deriving the aggregated trained model. In some embodiments, the processor aggregates the model parameters using federated learning, the transmitter transmits a response to the first request, and the response includes the aggregated model parameters.

Another embodiment of a method for model training using federated learning includes receiving, at a first network function, a first request from a second network function. The first request includes first requirements to derive a trained model, the first requirements include an analytics identifier identifying a model and requirements to provide the trained model for a specific area, a public land mobile network, a data network access identifier, a single network slice selection assistant information, an application identifier, a data network name, or some combination thereof. In some embodiments, the method includes determining that the first request uses federated learning to train the model corresponding to the first requirements. In certain embodiments, the method includes determining a network function that supports model aggregation using federated learning. In various embodiments, the method includes transmitting a second request to a third network function supporting model training using federated learning. The second request includes a request to provide a trained model using federated learning based on the first requirements. In some embodiments, the method includes, in response to transmitting the second request, receiving aggregated model parameters. In certain embodiments, the method includes training the model using the aggregated model parameters to result in a trained model. In various embodiments, the method includes transmitting a first response to the first request. The response includes information indicating that the trained model is available.

Another apparatus for model training using federated learning includes a first network function. In some embodiments, the apparatus includes a receiver that receives a first request from a second network function. The first request includes first requirements to derive a trained model, the first requirements include an analytics identifier identifying a model and requirements to provide the trained model for a specific area, a public land mobile network, a data network access identifier, a single network slice selection assistant information, an application identifier, a data network name, or some combination thereof. In various embodiments, the apparatus includes a processor that: determines that the first request uses federated learning to train the model corresponding to the first requirements; and determines a network function that supports model aggregation using federated learning. In certain embodiments, the apparatus includes a transmitter that transmits a second request to a third network function supporting model training using federated learning. The second request includes a request to provide a trained model using federated learning based on the first requirements. In some embodiments, in response to transmitting the second request, the receiver receives aggregated model parameters, the processor trains the model using the aggregated model parameters to result in a trained model, the transmitter transmits a first response to the first request, and the response includes information indicating that the trained model is available.

A further embodiment of a method for model training using federated learning includes receiving, at a second network function, a first request to provide an analytics report. In some embodiments, the method includes determining, at the second network function, that a trained model requires federated learning. In certain embodiments, the method includes transmitting, from the second network function, a second request to a first network function. The second request includes first requirements to derive the trained model, the first requirements include an analytics identifier identifying a model and requirements to provide the trained model for a specific area, a public land mobile network, a data network access identifier, a single network slice selection assistant information, an application identifier, a data network name, or some combination thereof. In various embodiments, the method includes receiving a response to the second request. The response includes information indicating that the trained model is available.

A further apparatus for model training using federated learning includes a second network function. In some embodiments, the apparatus includes a receiver that receives a first request to provide an analytics report. In various embodiments, the apparatus includes a processor that determines that a trained model requires federated learning. In certain embodiments, the apparatus includes a transmitter that transmits a second request to a first network function. The second request includes first requirements to derive the trained model, the first requirements include an analytics identifier identifying a model and requirements to provide the trained model for a specific area, a public land mobile network, a data network access identifier, a single network slice selection assistant information, an application identifier, a data network name, or some combination thereof. In some embodiments, the receiver receives a response to the second request. The response includes information indicating that the trained model is available.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for model training using federated learning;

FIG. 2 is a schematic block diagram illustrating one embodiment of an apparatus that may be used for model training using federated learning;

FIG. 3 is a schematic block diagram illustrating one embodiment of an apparatus that may be used for model training using federated learning;

FIG. 4 is a schematic block diagram illustrating one embodiment of a system for horizontal federated learning;

FIG. 5 is a schematic block diagram illustrating one embodiment of a system for vertical federated learning;

FIG. 6 is a schematic block diagram illustrating one embodiment of a system including a 3GPP architecture for federated learning;

FIG. 7 is a schematic block diagram illustrating another embodiment of a system including a 3GPP architecture for federated learning;

FIG. 8 is a network communications diagram illustrating one embodiment of a procedure for federated learning;

FIG. 9 is a network communications diagram illustrating another embodiment of a procedure for federated learning;

FIG. 10 is a network communications diagram illustrating one embodiment of a procedure for an MTLF aggregator to aggregate ML models based on federation learning;

FIG. 11 is a flow chart diagram illustrating one embodiment of a method for model training using federated learning;

FIG. 12 is a flow chart diagram illustrating another embodiment of a method for model training using federated learning; and

FIG. 13 is a flow chart diagram illustrating a further embodiment of a method for model training using federated learning.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

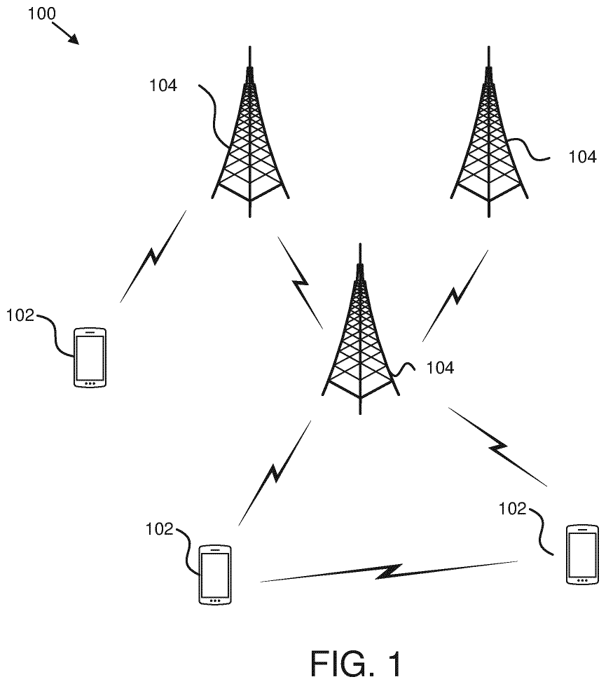

FIG. 1 depicts an embodiment of a wireless communication system 100 for model training using federated learning. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an AnLF, an MTLF, data producer NFs, an NRF, an MTLF aggregator, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a model training logical function that supports aggregation of model parameters using federated learning, a first request from a network function. The first request includes first requirements to derive an aggregated trained model using federated learning from at least one local model training logical function. In some embodiments, the network unit 104 may determine model parameters for aggregation using federated learning based on the first requirements in the first request. In certain embodiments, the network unit 104 may discover at least one local model training logical function that can provide model parameters for aggregation using federated learning based on the first requirements. In various embodiments, the network unit 104 may transmit a second request to the at least one local model training logical function to receive the model parameters for deriving the aggregated trained model. In some embodiments, the network unit 104 may aggregate the model parameters using federated learning. In certain embodiments, the network unit 104 may transmit a response to the first request. The response includes the aggregated model parameters. Accordingly, the network unit 104 may be used for model training using federated learning.

In certain embodiments, a network unit 104 may receive, at a first network function, a first request from a second network function. The first request includes first requirements to derive a trained model, the first requirements include an analytics identifier identifying a model and requirements to provide the trained model for a specific area, a public land mobile network, a data network access identifier, a single network slice selection assistant information, an application identifier, a data network name, or some combination thereof. In some embodiments, the network unit 104 may determine that the first request uses federated learning to train the model corresponding to the first requirements. In certain embodiments, the network unit 104 may determine a network function that supports model aggregation using federated learning. In various embodiments, the network unit 104 may transmit a second request to a third network function supporting model training using federated learning. The second request includes a request to provide a trained model using federated learning based on the first requirements. In some embodiments, the network unit 104 may, in response to transmitting the second request, receive aggregated model parameters. In certain embodiments, the network unit 104 may train the model using the aggregated model parameters to result in a trained model. In various embodiments, the network unit 104 may transmit a first response to the first request. The response includes information indicating that the trained model is available. Accordingly, the network unit 104 may be used for model training using federated learning.

In some embodiments, a network unit 104 may receive, at a second network function, a first request to provide an analytics report. In some embodiments, the network unit 104 may determine, at the second network function, that a trained model requires federated learning. In certain embodiments, the network unit 104 may transmit, from the second network function, a second request to a first network function. The second request includes first requirements to derive the trained model, the first requirements include an analytics identifier identifying a model and requirements to provide the trained model for a specific area, a public land mobile network, a data network access identifier, a single network slice selection assistant information, an application identifier, a data network name, or some combination thereof. In various embodiments, the network unit 104 may receive a response to the second request. The response includes information indicating that the trained model is available. Accordingly, the network unit 104 may be used for model training using federated learning.

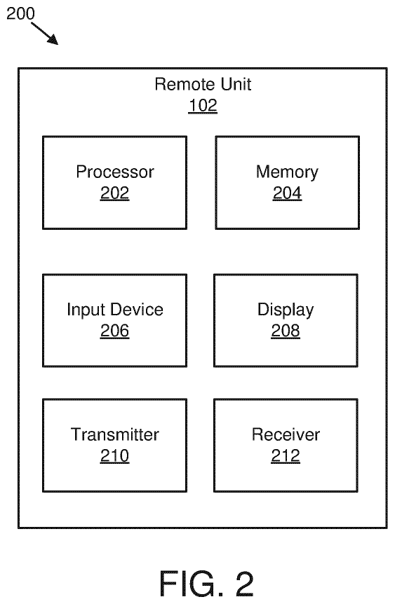

FIG. 2 depicts one embodiment of an apparatus 200 that may be used for model training using federated learning. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

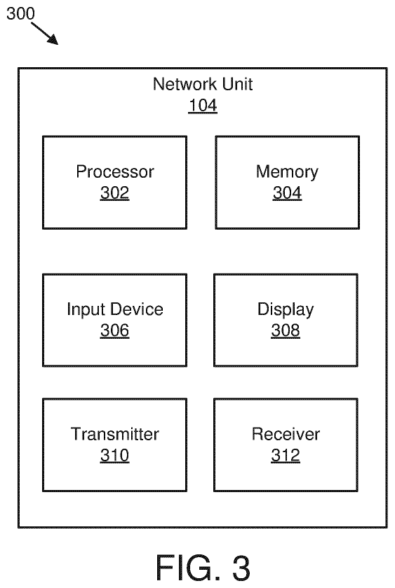

FIG. 3 depicts one embodiment of an apparatus 300 that may be used for model training using federated learning. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives a first request from a network function. The model training logical function supports aggregation of model parameters using federated learning, and the first request includes first requirements to derive an aggregated trained model using federated learning from at least one local model training logical function. In various embodiments, the processor 302: determines model parameters for aggregation using federated learning based on the first requirements in the first request; and discovers at least one local model training logical function that can provide model parameters for aggregation using federated learning based on the first requirements. In certain embodiments, the transmitter 310 transmits a second request to the at least one local model training logical function to receive the model parameters for deriving the aggregated trained model. In some embodiments, the processor 302 aggregates the model parameters using federated learning, the transmitter 310 transmits a response to the first request, and the response includes the aggregated model parameters.

In some embodiments, the receiver 312 receives a first request from a second network function. The first request includes first requirements to derive a trained model, the first requirements include an analytics identifier identifying a model and requirements to provide the trained model for a specific area, a public land mobile network, a data network access identifier, a single network slice selection assistant information, an application identifier, a data network name, or some combination thereof. In various embodiments, the processor 302: determines that the first request uses federated learning to train the model corresponding to the first requirements; and determines a network function that supports model aggregation using federated learning. In certain embodiments, the transmitter 310 transmits a second request to a third network function supporting model training using federated learning. The second request includes a request to provide a trained model using federated learning based on the first requirements. In some embodiments, in response to transmitting the second request, the receiver 312 receives aggregated model parameters, the processor 302 trains the model using the aggregated model parameters to result in a trained model, the transmitter 310 transmits a first response to the first request, and the response includes information indicating that the trained model is available.

In various embodiments, the receiver 312 receives a first request to provide an analytics report. In various embodiments, the processor 302 determines that a trained model requires federated learning. In certain embodiments, the transmitter 310 transmits a second request to a first network function. The second request includes first requirements to derive the trained model, the first requirements include an analytics identifier identifying a model and requirements to provide the trained model for a specific area, a public land mobile network, a data network access identifier, a single network slice selection assistant information, an application identifier, a data network name, or some combination thereof. In some embodiments, the receiver 312 receives a response to the second request. The response includes information indicating that the trained model is available.

In certain embodiments, federated learning may be supported in third generation partnership program (“3GPP”) network data analytics function (“NWDAF”) architecture and the following may be performed: 1) a network function (“NF”) identifies that federated learning is required; 2) a NF identifies what part of a training model requires federating learning; 3) a NF identifies and/or discovers a NF that supports federated learning and aggregation of trained model from one or more NFs supporting a model training function; and/or 4) a procedure for a NF that supports federated learning and aggregation of trained models to collects model parameters from NFs supporting model training.

As used herein, data producer NFs corresponds to any NF within a 3GPP network that can provide information related to an event identifier (“ID”). Data producer NFs may also be a data collection coordination function (“DCCF”) or an analytics data repository function (“ADRF”).

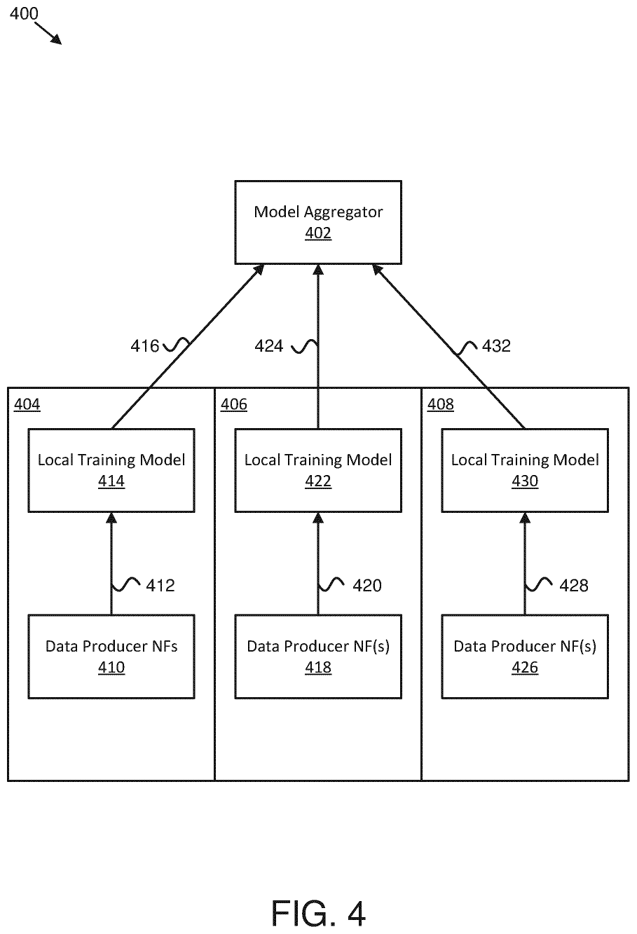

In some embodiments, horizontal federated learning applies if each isolated network (e.g., specific slice) has its own model training function to generate a model for a specific analytic ID and collects the required data (e.g., one or more event IDs from one or more data producer NFs) to derive analytics. Each slice may belong to the same public land mobile network (“PLMN”), but data from data producers may not be shared. Each PLMN collects the data required (e.g., event IDs) to generate a model for a specific analytics ID at a different sample space (e.g., different users or samples collected at different time of day) and creates local trained models. One embodiment of horizontal federated learning is shown in FIG. 4.

FIG. 4 is a schematic block diagram illustrating one embodiment of a system 400 for horizontal federated learning. The system 400 includes a model aggregator 402, a first slice 404, a second slice 406, and a third slice 408. The first slice 404 includes data producer NFs 410 that provide data 412 to a local training model 414 which provides model parameters 416 to the model aggregator 402. Moreover, the second slice 406 includes data producer NFs 418 that provide data 420 to a local training model 422 which provides model parameters 424 to the model aggregator 402. Further, the third slice 408 includes data producer NFs 426 that provide data 428 to a local training model 430 which provides model parameters 432 to the model aggregator 402. The data producer NFs 410, 418, and 426 provide data containing identical features (e.g., event IDs), but contains different samples (e.g., different users, different time of day).

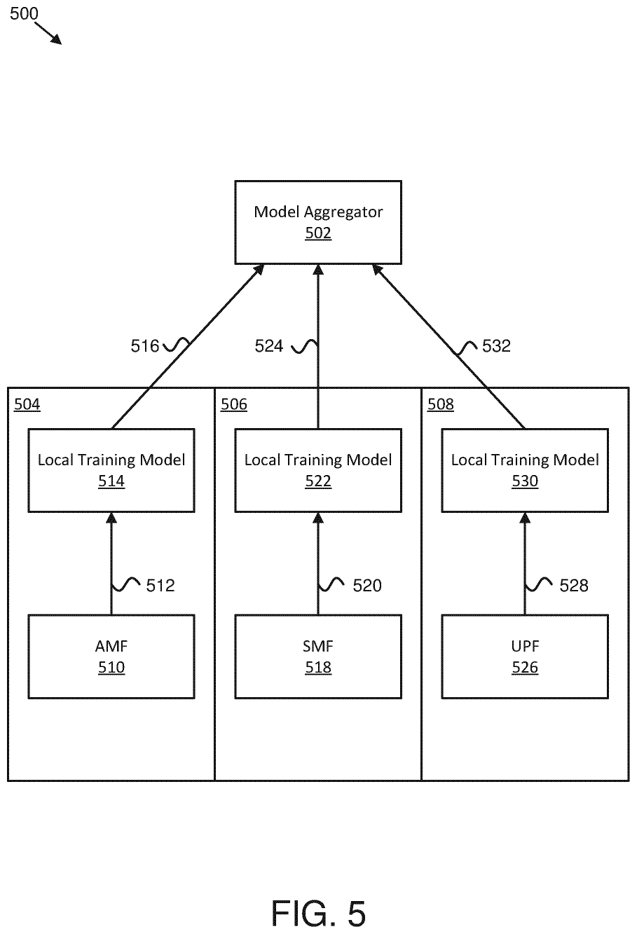

In contrast to horizontal federated learning, in vertical federated learning, each data producer NF collect data of different features (e.g., event IDs) at the same sample space (e.g., same user or samples collected at the same time of day). For example, an access and mobility management function (“AMF”) in one isolated network collects mobility information and a session management function (“SMF”) in a different isolated network collects session management information. Using vertical federated learning, each isolated network generates a partially trained model based on the data collected and send parameters of the partial trained models to a model aggregator. The model aggregator may be within or outside the isolated network. This is shown in FIG. 5.

FIG. 5 is a schematic block diagram illustrating one embodiment of a system 500 for vertical federated learning. The system 500 includes a model aggregator 502, a first slice 504, a second slice 506, and a third slice 508. The first slice 504 includes an AMF 510 that provides mobility data 512 to a local training model for mobility data 514 which provides model parameters 516 to the model aggregator 502. Moreover, the second slice 506 includes an SMF 518 that provides session management data 520 to a local training model for session management data 522 which provides model parameters 524 to the model aggregator 502. Further, the third slice 508 includes a user plane function (“UPF”) 526 that provides user plane data 528 to a local training model for user plane data 530 which provides model parameters 532 to the model aggregator 502. The data producer NFs (e.g., AMF 510, SMF 518, and UPF 526) provide data containing different features (e.g., event IDs), but for the same samples (e.g., for the same users, for the same time of day).

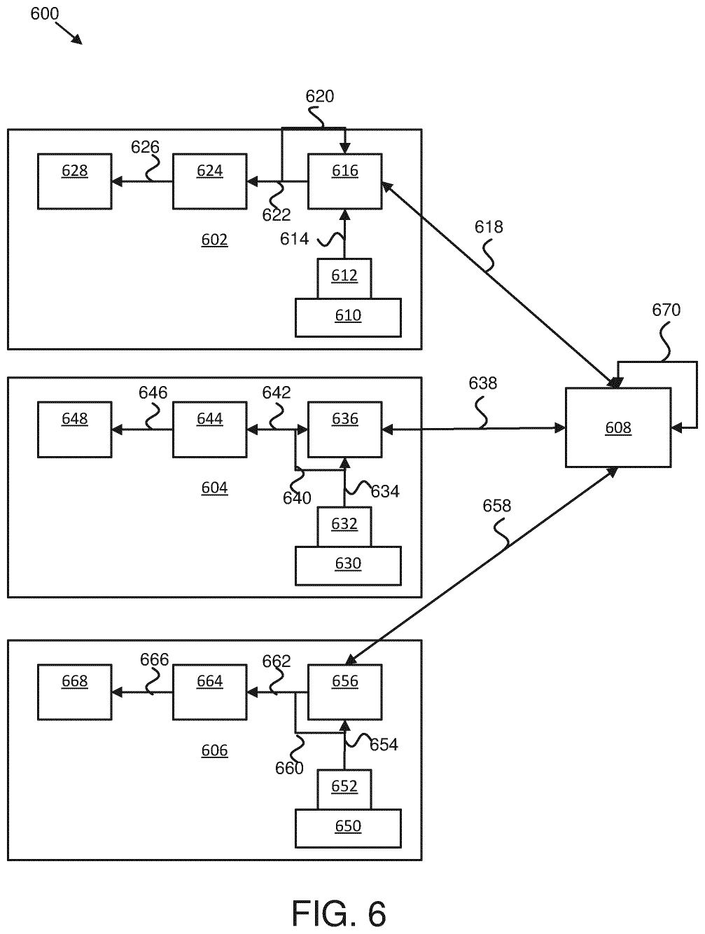

One embodiment of an architecture to support federated learning in 3GPP is shown in FIG. 6.

FIG. 6 is a schematic block diagram illustrating one embodiment of a system 600 including a 3GPP architecture for federated learning. The system 600 includes a first isolated network 602, a second isolated network 604, a third isolated network 606, and a model training logical function (“MTLF”) aggregator 608. In the first isolated network 602, data producer NFs 610 provide data to a MTLF function 612 which provides data and/or model parameters collection 614 to a MTLF 616. The MTLF 616 performs a model parameter exchange 618 with the MTLF aggregator 608. Moreover, the MTLF 616 performs model training 620 and provides a trained machine learning (“ML”) model 622 to an analytics logical function (“AnLF”) 624. The AnLF 624 provides analytics 626 to a consumer NF 628. Moreover, in the second isolated network 604, data producer NFs 630 provide data to a MTLF function 632 which provides data and/or model parameters collection 634 to a MTLF 636. The MTLF 636 performs a model parameter exchange 638 with the MTLF aggregator 608. Moreover, the MTLF 636 performs model training 640 and provides a trained ML model 642 to an AnLF 644. The AnLF 644 provides analytics 646 to a consumer NF 648. Further, in the third isolated network 606, data producer NFs 650 provide data to a MTLF function 652 which provides data and/or model parameters collection 654 to a MTLF 656. The MTLF 656 performs a model parameter exchange 658 with the MTLF aggregator 608. Moreover, the MTLF 656 performs model training 660 and provides a trained ML model 662 to an AnLF 664. The AnLF 664 provides analytics 666 to a consumer NF 668. The MTLF aggregator 608 aggregates 670 ML models.

Indeed, FIG. 6 shows an architecture where each network is isolated from one another. Each isolated network may be: 1) a specific network slice in a PLMN network; 2) a non-private network (“NPN”) (or a private network) hosted by a PLMN network or a third party; 3) from different PLMN operators; and/or 4) a specific network at an edge where data cannot be shared with a core network.

In such an architecture, the NF that supports model training (e.g., local MTLF) determines that a trained model requested by an AnLF requires federated learning. Factors that allow the local MTLF to determine whether federated learning is required may be based on the following factors: 1) data collected (e.g., one or more event IDs) cannot be collected directly from data producer NFs—this may be based on an NF not providing an event ID or part of the data within the data of the event ID is missing (e.g., missing user information); 2) a request to provide a trained model for a different PLMN; 3) a request to provide a trained model for one or more data network access identifiers (“DNAIs”) where federated learning is required; 4) a request to provide a trained model for one or more service areas where federated learning is required; 5) a request to provide a trained model for one or more network slices identified by an single network slice selection assistance information (“S-NSSAI”) where federating learning is required; and/or 6) a request to provide a trained model for a data network name (“DNN”) where federating learning is required.

In certain embodiments, once a local MTLF determines that federated learning is required, the MTLF discovers an MTLF aggregator that supports federated learning to receive updated model parameters and retrain its local trained model. In one embodiment, instead of discovering an MTLF aggregator, the local MTLF discovers an MTLF that can provide the updated model parameters to retrain the model (e.g., discover one or more MTLFs that can provide model parameters for a specific service area (e.g., PLMN, DNAI, DNN, or S-NSSAI)).

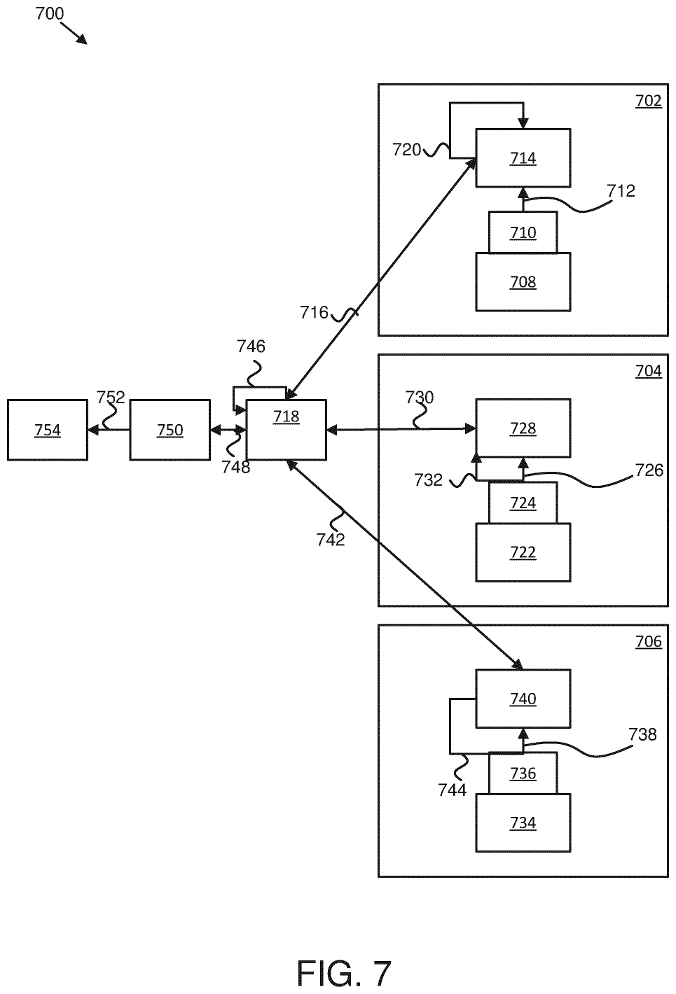

FIG. 7 shows an architecture where each a PLMN operator uses federated learning to optimize signaling efficiency. Such embodiments avoid having a centralized function to collect data from all data producer NFs where the AnLF function receives and uses one trained ML model to provide analytics to a consumer NF.

Specifically, FIG. 7 is a schematic block diagram illustrating another embodiment of a system 700 including a 3GPP architecture for federated learning. The system 700 includes an edge network 702, a roaming network 704, and a service area in a PLMN 706. The edge network 702 includes data producer NFs 708 that provide data to a MTLF function 710 which provides data and/or model parameters collection 712 to a local MTLF 714. The local MTLF 714 performs a model parameter exchange 716 with an MTLF aggregator 718. Moreover, the local MTLF 714 performs model training 720. Further, the roaming network 704 includes data producer NFs 722 that provide data to a MTLF function 724 which provides data and/or model parameters collection 726 to a local MTLF 728. The local MTLF 728 performs a model parameter exchange 730 with the MTLF aggregator 718. Moreover, the local MTLF 728 performs model training 732. The service area in a PLMN 706 includes data producer NFs 734 that provide data to a MTLF function 736 which provides data and/or model parameters collection 738 to a local MTLF 740. The local MTLF 740 performs a model parameter exchange 742 with the MTLF aggregator 718. Moreover, the local MTLF 740 performs model training 744. The MTLF aggregator 718 aggregates 746 local models then performs 748 a trained model exchange with an AnLF 750 which provides analytics 752 to a consumer NF 754.

In FIG. 7, the NF that supports analytics generation (e.g., AnLF) determines that a trained model required requires federated learning. Factors that allow the AnLF to determine whether federated learning is required may be based on the following factors: 1) data collected (e.g., one or more event IDs)—cannot be collected directly from data Producer NFs—this may be based on an NF not providing an event ID or part of the data within the data of the event ID is missing (e.g., missing user information); 2) a request is for analytics information for a different PLMN; 3) a request for analytics information for a DNAI where federated learning is required or the request is for a DNAI not supported by a current AnLF (e.g., if AnLF is configured to support specific edge networks identified by a DNAI); 4) a request for analytics information for a service area where federated learning is required or the request is for a service area not supported by the current AnLF (e.g., if AnLF is configured to support a specific service area); 5) a request for analytics information for a network slice where federated learning is required or the request is for a network slice not supported by the current AnLF (e.g., if AnLF is configured to support a specific network slice); and/or 6) a request for analytics information for a DNN where federated learning is required.

In some embodiments, once the AnLF determines that federated learning is required, the AnLF discovers an MTLF aggregator that supports federated learning to receive an aggregate trained model. In one embodiment, instead of discovering an MTLF aggregator, the AnLF discovers an MTLF that can provide an aggregate trained model (e.g., discover one or more MTLFs that may provide model parameters for a specific service area, PLMN, DNAI, DNN, or S-NSSAI).

In various embodiments, an MTLF aggregator is a NF within a PLMN network. In certain embodiments, an MTLF aggregator is an application function (“AF”) located in a PLMN or by a third party network.

In some embodiments, if an MTLF aggregator is an AF, the MTLF aggregator may receive parameters related to local trained models from a device. In various embodiments, an MTLF aggregator may be collocated with an MTLF NF (e.g., distributed approach). In certain embodiments, a process for aggregating a model is distributed across multiple MTLFs. In such embodiments, each MTLF discovers an MTLF that can provide updated model parameters for generating an aggregated model.

In various embodiments, an MTLF aggregator supporting federated learning collects model parameters (e.g., gradients and loss of an ML model) from each local MTLF function and generates an aggregated ML model based on parameters provided by each MTLF. In such embodiments, each local MTLF may provide a trained ML model for an analytics ID or may provide a partially trained model for data collected by a data producer NF. For example, a partially trained ML model may provide information about user equipment (“UE”) mobility data collected by an AMF. The generation of the partially trained model may be supported by a function supporting MTLF capabilities within the data producer NF and/or DCCF or may be a function of the MTLF. An MTLF and/or data producer NF may register its capability to a network repository function (“NRF”) to generate partially trained ML models.

In certain embodiments, an MTLF aggregator sends back to each MTLF calculated gradients and loss factors that are used by the MTLF to generate new trained ML models.

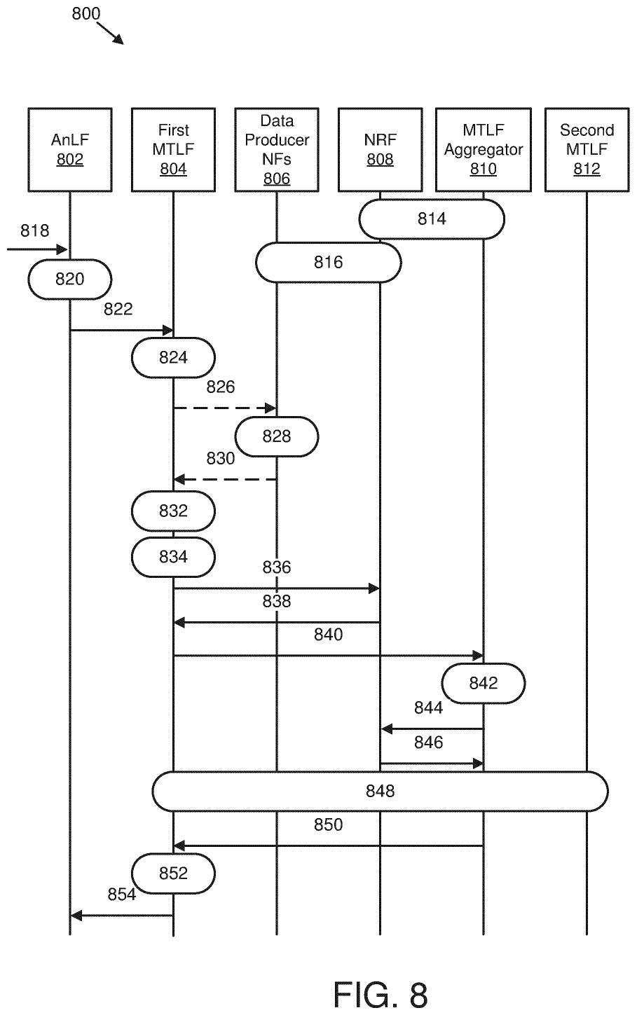

One embodiment for supporting federated learning is found in FIG. 8.

Specifically, FIG. 8 is a network communications diagram 800 illustrating one embodiment of a procedure for federated learning. The diagram 800 includes an AnLF 802 (e.g., analytics interference NWDAF, consumer NF), a first MTLF 804, data producer NFs 806 (e.g., and/or DCCF), an NRF 808, an MTLF aggregator 810, and a second MTLF 812. It should be noted that the illustrated communications may include one or more messages.

In a first communication 814 transmitted between the NRF 808 and the MTLF aggregator 810, the MTLF aggregator 810 may register to the NRF 808 its capability to aggregate models including service areas, DNAIs, S-NSSAIs, application IDs, DNNs, and/or event IDs supported.

In a second communication 816 transmitted between the data producer NFs 806 and the NRF 808, the data producer NFs 806 (e.g., DCCF, ADRF, NF) may register to the NRF 808 (or another NF) that some event IDs cannot be collected due to various requirements (e.g., privacy requirements).

In a third communication 818 transmitted to the AnLF 802, the AnLF 802 receives a request to provide analytics report. The request includes an analytics ID that defines an analytic report requested and may include as analytics filters, a list of service area information, PLMN IDs (e.g., if the consumer NF is from a different PLMN), DNAI (e.g., if the consumer NF requires analytics for a particular edge network identified by a DNAI), network slices identified by S-NSSAI, and/or DNNs.

The AnLF 802 determines 820 a trained model is required to derive such analytics. The AnLF 802 may determine a trained model is needed based on an internal trigger without waiting for an analytics request.

In a fourth communication 822 transmitted from the AnLF 802 to the first MTLF 804, if the AnLF 802 has no available trained model, the AnLF 802 requests a trained model from the first MTLF 804. The request includes an analytics ID, an analytics filters service area, a PLMN ID, and/or DNAI. If step 818 takes place, the AnLF 802 includes as analytics filters the analytics filter included in step 802.

The first MTLF 804 determines 824 a model is required to be trained.

In an optional fifth communication 826 transmitted from the first MTLF 804 to the data producer NFs 806, the first MTLF 804 may request data to train the model either from a DCCF, ADRF, or directly from the data producer NFs 806.

In some embodiments, the data producer NFs 806 (e.g., and/or DCCF and/or ADRF) determines 828 that data cannot be provided due to privacy requirements.

In an optional sixth communication 830 transmitted from the data producer NFS 806 to the first MTLF 804, the data producer NFs 806 (e.g., and/or DCCF and/or ADRF) provide an indication to the first MTLF 804 that data cannot be provided.

The first MTLF 804 determines 832 that federated learning is required to train the model. The first MTLF 804 may determine federated learning is required due to the following reasons: 1) data collected (e.g., one or more event IDs) cannot be collected directly from the data producer NFs, or data within the provided event ID are not included (e.g., missing user information) (due to steps 826-828, due to internal configuration, due to information from the NRF 808, or due to a local configuration); 2) the request is for analytics information from a different PLMN; 3) the request for analytics information is for one or more DNAIs where federated learning is required; 4) the request for analytics information is for one or more service areas where federated learning is required; 5) the request for analytics information is for one or more network slices identified by an S-NSSAI where federating learning is required; and/or 6) the request for analytics information is for a DNN where federating learning is required.

If the first MTLF 804 requires local trained models, the first MTLF 804 determines 834 what data (e.g., event IDs) cannot be collected directly from one or more NFs from the data (e.g., event IDs) required to train a model based on steps 826 to 830 or based on internal configuration.

In a seventh communication 836 transmitted from the first MTLF 804 to the NRF 808, the first MTLF 804 discovers the MTLF aggregator 810 from the NRF 808. The MTLF aggregator 810 may be an MTLF in the PLMN or may be a third party AF. The request to the NRF 808 includes the analytics ID, service area, DNAI, and PLMN if included in step 820 and includes the event IDs that cannot be collected directly from one or more NFs based on steps 826 through 830. In some embodiments, the first MTLF 804 discovers an MTLF that serves the required S-NSSAI, DNAI, or service area to receive updated model parameters. In such an embodiment, the first MTLF 804 sends a request to the determined MTLF instead of sending a request to an MTLF aggregator.

In an eighth communication 838 transmitted from the NRF 808 to the first MTLF 804, the NRF 808 provides the MTLF aggregator 810 and/or MTLF NF ID to the first MTLF 804.

In a ninth communication 840 transmitted from the first MTLF 804 to the MTLF aggregator 810, the first MTLF 804 sends a request to the MTLF aggregator 810 for a trained model including an indication that federated learning is required, the analytics ID of the model required, and one or more of the following information to allow the MTLF aggregator 810 to determine what model is required: the event IDs where data cannot be collected directly, service area information, DNAIs, S-NSSAIs, application IDs, and/or DNNs.

The MTLF aggregator 810 determines 842 the MTLFs required to initiate federated learning. The determination is based on the event IDs where data could not be collected, service area, DNAI, S-NSSAI, and/or DNN information. An MTLF may be a separate function or may be a function supported within a data producer NF.

In a tenth communication 844 transmitted from the MTLF aggregator 810 to the NRF 808, the MTLF aggregator 810 discovers an MTLF, or local MTLFs from the NRF 808. The discovery request includes the event IDs if local trained models are required, service area, DNAI, S-NSSAI, and/or DNN.

In an eleventh communication 846 transmitted from the NRF 808 to the MTLF aggregator 810, the NRF 808 sends an NF discovery response (e.g., including MTLF NF ID) to the MTLF aggregator 810, and the MTLF aggregator 810 trains the model using the discovered MTLFs.

In a twelfth communication 848 transmitted between the first MTLF 804 and in a thirteenth communication 850 transmitted from the MTLF aggregator 810 to the first MTLF 804, the NRF 808, the MTLF aggregator 810, and the second MTLF 812, the MTLF aggregator 810 provides to the first MTLF 804 the re-trained model parameters. This may be a response to the message in step 822 or a new message.

The first MTLF 804 updates 852 its trained model using the model parameters

In a fourteenth communication 854 transmitted from the first MTLF 804 to the AnLF 802, the first MTLF 804 indicates to the AnLF 802 that a trained model is available.

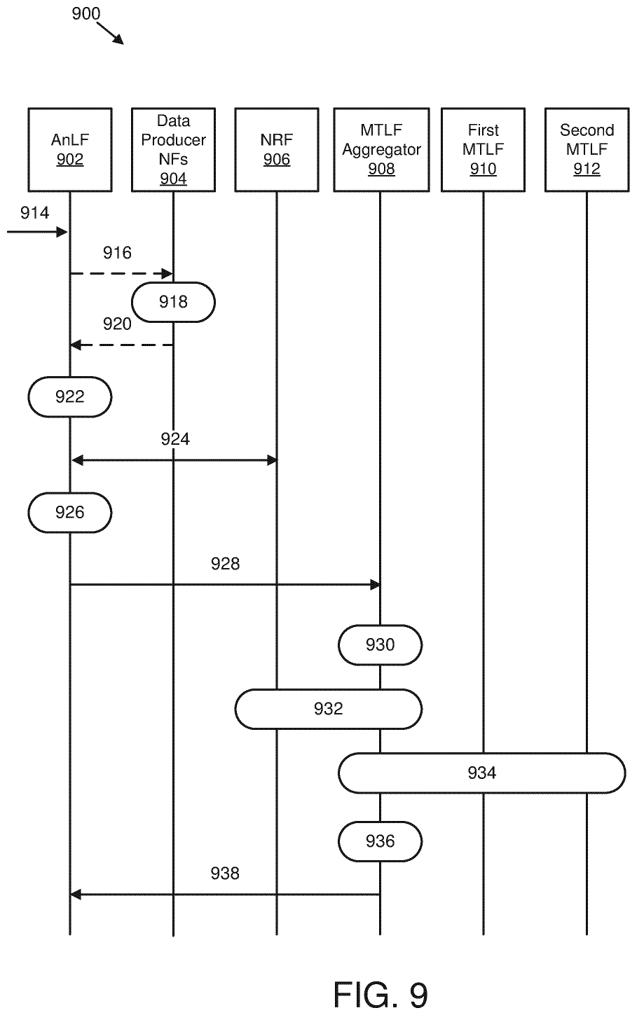

FIG. 9 is a network communications diagram illustrating another embodiment of a procedure for federated learning. The diagram 900 includes an AnLF 902 (e.g., analytics interference NWDAF, consumer NF), data producer NFs 904 (e.g., and/or DCCF), an NRF 906, an MTLF aggregator 908, a first MTLF 910, and a second MTLF 912. It should be noted that the illustrated communications may include one or more messages.

Steps 814 and 816 of FIG. 8 may be performed as part of FIG. 9.

In a first communication 914 received by the AnLF 902, the AnLF 902 receives a request from a consumer NF to provide an analytics report. The request includes an analytics ID that defines the analytic report requested and may include analytics filters, service area information, PLMN IDs (e.g., if the consumer NF is from a different PLMN), DNAI (e.g., if the consumer NF requires analytics for a particular edge network identified by a DNAI), S-NSSAIs (e.g., if the consumer requires analytics for one or more network slices), application IDs, and/or DNNs.

In an optional second communication 916 transmitted from the AnLF 902 to the data producer NFs 904, the AnLF 902 may request data to train a model from the data producer NFs 904.

The data producer NFs 904 (and/or DCCF and/or ADRF) determines 918 that data cannot be provided due to various requirements (e.g., privacy requirements).

In an optional third communication 920 transmitted from the data producer NFs 904 to the AnLF 902, the data producer NFs 904 (and/or DCCF and/or ADRF) provides an indication to the AnLF 902 that data cannot be provided.

The AnLF 902 determines 922 that federated learning is required to train the model. The AnLF 902 may determine that federated learning is required due to the following reasons: 1) data cannot be collected directly from an NF (e.g., due to steps 916 through 920, due to internal configuration, or due to information from NRF); 2) the request is for analytics information from a different PLMN; 3) the request for analytics information is for a DNAI where federated learning is required; 4) the request for analytics information is for a service area where federated learning is required; 5) the request for analytics information is for network slice where federated learning is required; and/or 6) the request for analytics information is for a DNN where federated learning is required.

In a fourth communication 924 transmitted between the AnLF 902 and the NRF 906, the AnLF 902 discovers the MTLF aggregator 908 from the NRF 906. The MTLF aggregator 908 may be an MTLF in the PLMN or may be a third party AF. The AnLF 902 discovers the MTLF aggregator 908 by providing analytics ID, service area, DNAI or event IDs, S-NSSAI, application IDs, and/or DNNs.

The AnLF 902 determines 926 what data (e.g., event IDs) cannot be collected directly from one or more NFs from the data (e.g., event IDs) required to train a model.

In a fifth communication 928 transmitted from the AnLF 902 to the MTLF aggregator 908, the AnLF 902 sends a request to the MTLF aggregator 908 for a trained model including an indication that federated learning is required, the analytics ID of the model required, and one or more of the following: the event IDs where data cannot be collected directly, service area information, DNAIs, S-NSSAIs, application IDs, and/or DNNs.

The MTLF aggregator 908 determines 930 the MTLFs required to initiate federated learning. The determinations is based on the event IDs where data could not be collected, service area information, and/or DNAI information.

In a sixth communication 932 transmitted between the NRF 906 and the MTLF aggregator 908, the MTLF aggregator 908 discovers the MTLFs from the NRF 906. The discovery request includes the event IDs, service area, and/or DNAI.

In a seventh communication 934 between the MTLF aggregator 908, the first MTLF 910, and the second MTLF 912, the MTLF aggregator 908 trains the model using the discovered MTLFs.

The MTLF aggregator 908 updates 936 its trained model using the model parameters.

In an eighth communication 938 transmitted from the MTLF aggregator 908 to the AnLF 902, the MTLF aggregator 908 indicates to the AnLF 902 that a trained model is available.

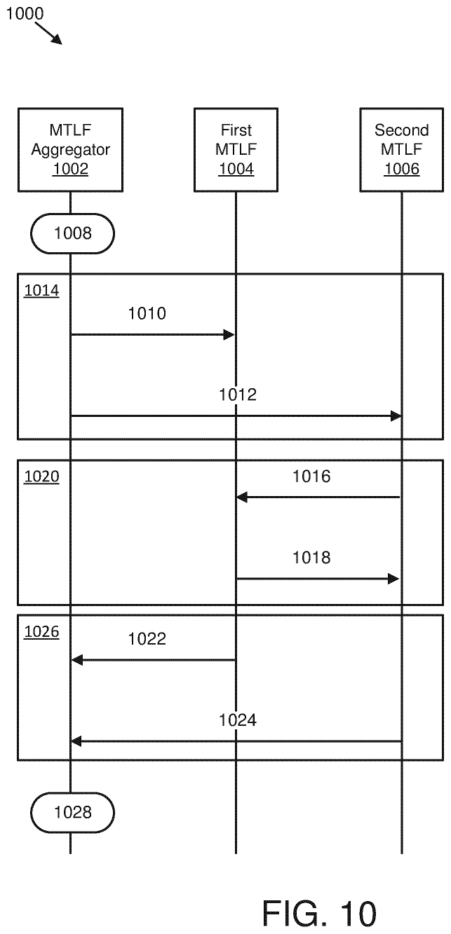

FIG. 10 is a network communications diagram 1000 illustrating one embodiment of a procedure for an MTLF aggregator to aggregate ML models based on federation learning. The diagram 1000 includes an MTLF aggregator 1002, a first MTLF 1004, and a second MTLF 1006. It should be noted that the illustrated communications may include one or more messages.

The MTLF aggregator 1002 determines 1008 the MTLFs for federated learning. Based on the information provided by an NRF, the MTLF aggregator 1002 determines what event IDs, service area, DNAI, PLMN, S-NSSAI, application ID, and/or DNNs each MTLF supports for federated learning. In this example, the MTLF aggregator 1002 discovers two MTLFs (e.g., the first MTLF 1004 and the second MTLF 1006) where each MTLF support different service areas, DNAI, S-NSSAI, application ID, event IDs, PLMN, and/or or DNNs.

In a first communication 1010 transmitted from the MTLF aggregator 1002 to the first MTLF 1004, the MTLF aggregator 1002 sends a request for federated learning to the first MTLF 1004 where the request includes an analytic ID of the model required, a federated learning indication, and one or more of the following: event IDs needed, service area, and/or DNAI. The MTLF aggregator 1002 includes a public key to encrypt data and may include an address of the second MTLF 1006 (e.g., if vertical federated learning is required).

In a second communication 1012 transmitted from the MTLF aggregator 1002 to the second MTLF 1006, the MTLF aggregator 1002 repeats step 1010 for the second MTLF 1006. The request includes one or more of the following: event IDs needed, service area, and/or DNAI. The MTLF aggregator 1002 also includes the public key provided in step 1010 to encrypt the data and the address of the first MTLF 1004 (e.g., if vertical federated learning is required). The first communication 1010 and the second communication 1012 may be grouped together as communications 1014 that exchange keys for sharing model parameters.

In a third communication 1016 transmitted from the second MTLF 1006 to the first MTLF 1004 and in a fourth communication 1018 transmitted from the first MTLF 1004 to the second MTLF 1006, the first MTLF 1004 and the second MTLF 1006 share initial data to identify initial model parameters. The message exchange may be encrypted using the public key provided by the MTLF aggregator 1002. The third communication 1016 and the fourth communication 1018 may be grouped together as communications 1020 that have an initial data exchange.

In a fifth communication 1022 transmitted from the first MTLF 1004 to the MTLF aggregator 1002, the first MTLF 1004 provides model parameters (e.g., gradient and loss) to the MTLF aggregator 1002. The message exchange may be encrypted using the public key provided by the MTLF aggregator 1002.

In a sixth communication 1024 transmitted from the second MTLF 1006 to the MTLF aggregator 1002, the second MTLF 1006 provides model parameters (e.g., gradient and loss) to the MTLF aggregator 1002. The message exchange may be encrypted using the public key provided by the MTLF aggregator 1002. The fifth communication 1022 and the sixth communication 1024 may be grouped together as communications 1026 that exchange modal parameters and/or gradients.

The MTLF aggregator 1002 calculates 1028 aggregated model parameters.

In various embodiments, if an MTLF subscribes to raw data from data producer NFs, the data producer NFs may provide model parameters corresponding to the raw data collected. The MTLF may then build an aggregated model taking into account the model parameters provided by the data producer NFs or may discover an MTLF aggregator to generate an aggregate model.

In certain embodiments, if an MTLF aggregator and/or an MTLF initiates federation learning between one or more local MTLFs, the MTLF aggregator and/or the MTLF may provide the local MTLFs with a local model to initiate training. In one embodiment, the MTLF aggregator determines the local model based on the data (e.g., one or more event IDs) required to be collected to train the aggregate model. The local MTLFs may be located in an NF, AF, or a UE. The MTLF aggregator provides local models to the UE via the AF. The local MTLF trains the provided local models with data collected from the local data producer NFs (i.e., data producer NFs that are in the same isolated network with the local MTLF). The local MTLF then provides the gradient and losses to the MTLF aggregator to derive an aggregate trained model.

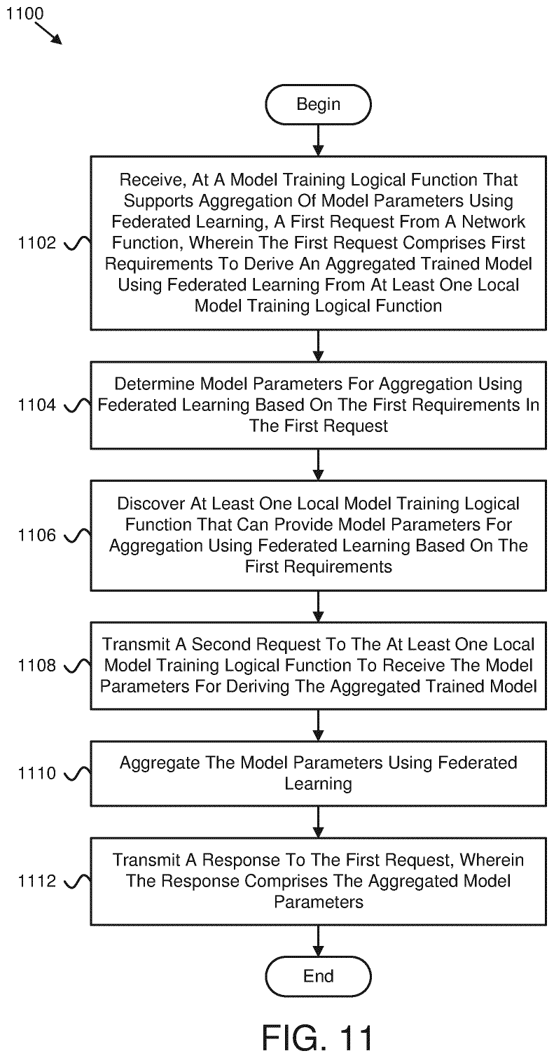

FIG. 11 is a flow chart diagram illustrating one embodiment of a method 1100 for model training using federated learning. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes receiving 1102, at a model training logical function that supports aggregation of model parameters using federated learning, a first request from a network function. The first request includes first requirements to derive an aggregated trained model using federated learning from at least one local model training logical function. In some embodiments, the method 1100 includes determining 1104 model parameters for aggregation using federated learning based on the first requirements in the first request. In certain embodiments, the method 1100 includes discovering 1106 at least one local model training logical function that can provide model parameters for aggregation using federated learning based on the first requirements. In various embodiments, the method 1100 includes transmitting 1108 a second request to the at least one local model training logical function to receive the model parameters for deriving the aggregated trained model. In some embodiments, the method 1100 includes aggregating 1110 the model parameters using federated learning. In certain embodiments, the method 1100 includes transmitting 1112 a response to the first request. The response includes the aggregated model parameters.

In certain embodiments, the at least one local model training logical function comprises at least one network function or at least one application function. In some embodiments, the network function comprises an analytics logical function, a model training logical function, or a combination thereof. In various embodiments, the method 1100 further comprises discovering a first list comprising the at least one local model training logical function.

In one embodiment, the first requirements comprise requirements to provide the aggregated training model using federated learning for a specific area, a public land mobile network, a data network access identifier, a single network slice selection assistant information, an application identifier, a data network name, or some combination thereof. In certain embodiments, the method 1100 further comprises discovering at least one local model training logical function to retrieve model parameters for federated learning from a network repository function.

In some embodiments, the method 1100 further comprises transmitting a third request to the network repository function to discover the local model training logical function to retrieve model parameters for federated learning, wherein the third request comprises a specific area, a public land mobile network, a data network access identifier, a single network slice selection assistant information, an application identifier, a data network name, or some combination thereof. In various embodiments, the model training logical function provisions local models to the local model training logical functions to initiate local training. In one embodiment, the local model training logical function trains the local model with data collected from local data producer network function and provides model parameters related to the trained local model to the model training logical function.

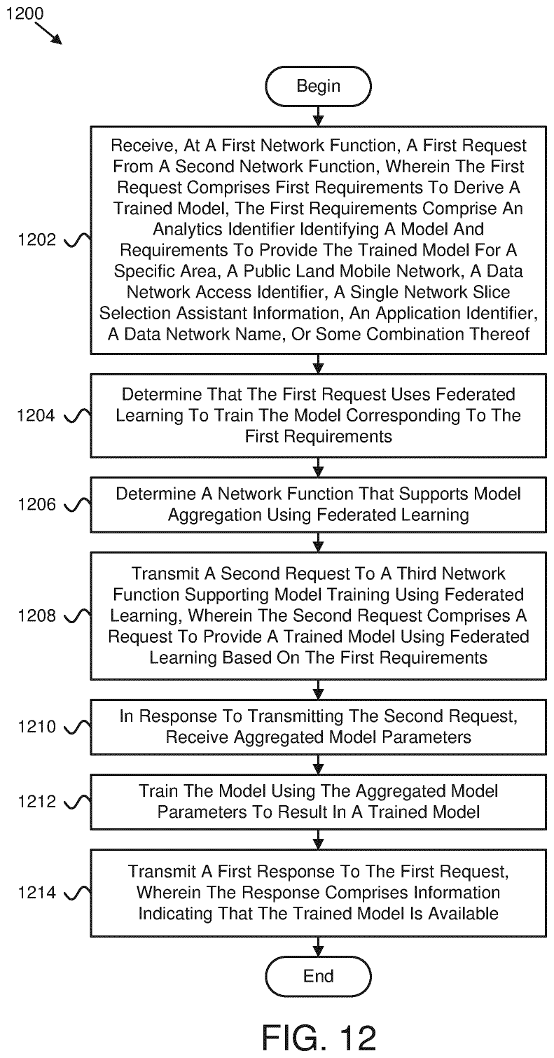

FIG. 12 is a flow chart diagram illustrating one embodiment of a method 1200 for model training using federated learning. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes receiving 1202, at a first network function, a first request from a second network function. The first request includes first requirements to derive a trained model, the first requirements include an analytics identifier identifying a model and requirements to provide the trained model for a specific area, a public land mobile network, a data network access identifier, a single network slice selection assistant information, an application identifier, a data network name, or some combination thereof. In some embodiments, the method 1200 includes determining 1204 that the first request uses federated learning to train the model corresponding to the first requirements. In certain embodiments, the method 1200 includes determining 1206 a network function that supports model aggregation using federated learning. In various embodiments, the method 1200 includes transmitting 1208 a second request to a third network function supporting model training using federated learning. The second request includes a request to provide a trained model using federated learning based on the first requirements. In some embodiments, the method 1200 includes, in response to transmitting the second request, receiving 1210 aggregated model parameters. In certain embodiments, the method 1200 includes training 1212 the model using the aggregated model parameters to result in a trained model. In various embodiments, the method 1200 includes transmitting 1214 a first response to the first request. The response includes information indicating that the trained model is available.

In certain embodiments, determining that the first request uses federated learning to train the model corresponding to the first requirements comprises receiving a second response from a data producer network function, and the second response is received in response to a request for data collection. In some embodiments, the second response indicates that data is unavailable.

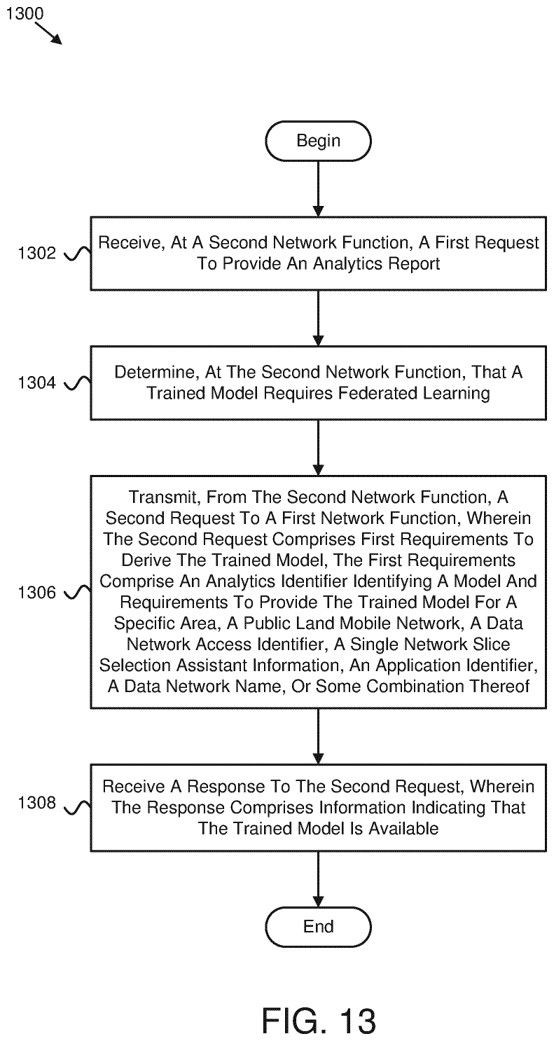

FIG. 13 is a flow chart diagram illustrating one embodiment of a method 1300 for model training using federated learning. In some embodiments, the method 1300 is performed by an apparatus, such as the network unit 104. In certain embodiments, the method 1300 may be performed by a processor executing program code, for example, a microcontroller, a microprocessor, a CPU, a GPU, an auxiliary processing unit, a FPGA, or the like.

In various embodiments, the method 1300 includes receiving 1302, at a second network function, a first request to provide an analytics report. In some embodiments, the method 1300 includes determining 1304, at the second network function, that a trained model requires federated learning. In certain embodiments, the method 1300 includes transmitting 1306, from the second network function, a second request to a first network function. The second request includes first requirements to derive the trained model, the first requirements include an analytics identifier identifying a model and requirements to provide the trained model for a specific area, a public land mobile network, a data network access identifier, a single network slice selection assistant information, an application identifier, a data network name, or some combination thereof. In various embodiments, the method 1300 includes receiving 1308 a response to the second request. The response includes information indicating that the trained model is available.

In certain embodiments, the method 1300 further comprises transmitting the analytics report in response to the first request.

In one embodiment, a method comprises: receiving, at a model training logical function that supports aggregation of model parameters using federated learning, a first request from a network function, wherein the first request comprises first requirements to derive an aggregated trained model using federated learning from at least one local model training logical function; determining model parameters for aggregation using federated learning based on the first requirements in the first request; discovering at least one local model training logical function that can provide model parameters for aggregation using federated learning based on the first requirements; transmitting a second request to the at least one local model training logical function to receive the model parameters for deriving the aggregated trained model; aggregating the model parameters using federated learning; and transmitting a response to the first request, wherein the response comprises the aggregated model parameters.

In certain embodiments, the at least one local model training logical function comprises at least one network function or at least one application function.

In some embodiments, the network function comprises an analytics logical function, a model training logical function, or a combination thereof.

In various embodiments, the method further comprises discovering a first list comprising the at least one local model training logical function.

In one embodiment, the first requirements comprise requirements to provide the aggregated training model using federated learning for a specific area, a public land mobile network, a data network access identifier, a single network slice selection assistant information, an application identifier, a data network name, or some combination thereof.

In certain embodiments, the method further comprises discovering at least one local model training logical function to retrieve model parameters for federated learning from a network 25 repository function.

In some embodiments, the method further comprises transmitting a third request to the network repository function to discover the local model training logical function to retrieve model parameters for federated learning, wherein the third request comprises a specific area, a public land mobile network, a data network access identifier, a single network slice selection assistant information, an application identifier, a data network name, or some combination thereof.

In various embodiments, the model training logical function provisions local models to the local model training logical functions to initiate local training.

In one embodiment, the local model training logical function trains the local model with data collected from local data producer network function and provides model parameters related to the trained local model to the model training logical function.

In one embodiment, an apparatus comprises a model training logical function. The apparatus further comprises: a receiver that receives a first request from a network function, wherein the model training logical function supports aggregation of model parameters using federated learning, and the first request comprises first requirements to derive an aggregated trained model using federated learning from at least one local model training logical function; a processor that: determines model parameters for aggregation using federated learning based on the first requirements in the first request; and discovers at least one local model training logical function that can provide model parameters for aggregation using federated learning based on the first requirements; and a transmitter that transmits a second request to the at least one local model training logical function to receive the model parameters for deriving the aggregated trained model; wherein the processor aggregates the model parameters using federated learning, the transmitter transmits a response to the first request, and the response comprises the aggregated model parameters.

In certain embodiments, the at least one local model training logical function comprises at least one network function or at least one application function.

In some embodiments, the network function comprises an analytics logical function, a model training logical function, or a combination thereof.

In various embodiments, the processor discovers a first list comprising the at least one local model training logical function.

In one embodiment, the first requirements comprise requirements to provide the aggregated training model using federated learning for a specific area, a public land mobile network, a data network access identifier, a single network slice selection assistant information, an application identifier, a data network name, or some combination thereof.

In certain embodiments, the processor discovers at least one local model training logical function to retrieve model parameters for federated learning from a network repository function.

In some embodiments, the transmitter transmits a third request to the network repository function to discover the local model training logical function to retrieve model parameters for federated learning, and the third request comprises a specific area, a public land mobile network, a data network access identifier, a single network slice selection assistant information, an application identifier, a data network name, or some combination thereof.

In various embodiments, the model training logical function provisions local models to the local model training logical functions to initiate local training.

In one embodiment, the local model training logical function trains the local model with data collected from local data producer network function and provides model parameters related to the trained local model to the model training logical function.

In one embodiment, a method comprises: receiving, at a first network function, a first request from a second network function, wherein the first request comprises first requirements to derive a trained model, the first requirements comprise an identifier of a model for training and requirements to provide the trained model for a specific area, a public land mobile network, a data network access identifier, a single network slice selection assistant information, an application identifier, a data network name, or some combination thereof; determining that the first request uses federated learning to train the model corresponding to the first requirements; determining a network function that supports model aggregation using federated learning; transmitting a second request to a third network function supporting model training using federated learning, wherein the second request comprises a request to provide a trained model using federated learning based on the first requirements; in response to transmitting the second request, receiving aggregated model parameters; training the model using the aggregated model parameters to result in a trained model; and transmitting a first response to the first request, wherein the response comprises information indicating that the trained model is available.

In certain embodiments, determining that the first request uses federated learning to train the model corresponding to the first requirements comprises receiving a second response from a data producer network function, and the second response is received in response to a request for data collection.

In some embodiments, the second response indicates that data is unavailable.

In one embodiment, an apparatus comprising a first network function. The apparatus further comprises: a receiver that receives a first request from a second network function, wherein the first request comprises first requirements to derive a trained model, the first requirements comprise an identifier of a model for training and requirements to provide the trained model for a specific area, a public land mobile network, a data network access identifier, a single network slice selection assistant information, an application identifier, a data network name, or some combination thereof; a processor that: determines that the first request uses federated learning to train the model corresponding to the first requirements; and determines a network function that supports model aggregation using federated learning; and a transmitter that transmits a second request to a third network function supporting model training using federated learning, wherein the second request comprises a request to provide a trained model using federated learning based on the first requirements; wherein, in response to transmitting the second request, the receiver receives aggregated model parameters, the processor trains the model using the aggregated model parameters to result in a trained model, the transmitter transmits a first response to the first request, and the response comprises information indicating that the trained model is available.

In certain embodiments, the processor determining that the first request uses federated learning to train the model corresponding to the first requirements comprises the receiver receiving a second response from a data producer network function, and the second response is received in response to a request for data collection.

In some embodiments, the second response indicates that data is unavailable.

In one embodiment, a method comprises: receiving, at a second network function, a first request to provide an analytics report; determining, at the second network function, that a trained model requires federated learning; transmitting, from the second network function, a second request to a first network function, wherein the second request comprises first requirements to derive the trained model, the first requirements comprise an identifier of a model for training and requirements to provide the trained model for a specific area, a public land mobile network, a data network access identifier, a single network slice selection assistant information, an application identifier, a data network name, or some combination thereof; and receiving a response to the second request, wherein the response comprises information indicating that the trained model is available.

In certain embodiments, the method further comprises transmitting the analytics report in response to the first request.

In one embodiment, an apparatus comprises a second network function. The apparatus further comprises: a receiver that receives a first request to provide an analytics report; a processor that determines that a trained model requires federated learning; and a transmitter that transmits a second request to a first network function, wherein the second request comprises first requirements to derive the trained model, the first requirements comprise an identifier of a model for training and requirements to provide the trained model for a specific area, a public land mobile network, a data network access identifier, a single network slice selection assistant information, an application identifier, a data network name, or some combination thereof; wherein the receiver receives a response to the second request, wherein the response comprises information indicating that the trained model is available.

In certain embodiments, the transmitter transmits the analytics report in response to the first request.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An user equipment (UE), comprising:
at least one memory; and
at least one processor coupled with the at least one memory and configured to cause the UE to:
receive a first request from a network function, wherein the first request comprises first requirements to provide a trained model;
determine model parameters for aggregation using federated learning based on the first requirements in the first request;
discover at least one local model training logical function that can provide model parameters for aggregation using federated learning based on the first requirements;
transmit a second request to the at least one local model training logical function to receive the model parameters for deriving the aggregated trained model; and
aggregate the model parameters using federated learning, transmit a response to the first request, and the response comprises the aggregated model parameters.

2. The UE of claim 1, wherein the at least one local model training logical function comprises at least one network function or at least one application function.

3. The UE of claim 2, wherein the network function comprises an analytics logical function, a model training logical function, or a combination thereof.

4. The UE of claim 3, wherein the first requirements to derive the aggregated training model using federated learning comprises an analytics identifier identifying a model, identifiers corresponding to the data that cannot be collected, a specific area of interest, a public land mobile network identifier, a data network access identifier, a single network slice selection assistant information identifier, an application identifier, a data network name identifier, or a combination thereof.

5. The UE of claim 4, wherein the at least one processor is configured to cause the UE to discover at least one local model training logical function to retrieve model parameters for federated learning from a network repository function.

6. The UE of claim 5, wherein the at least one processor is configured to cause the UE to transmit a third request to the network repository function to discover the local model training logical function to retrieve model parameters for federated learning, and the third request comprises a specific area, a public land mobile network, a data network access identifier, a single network slice selection assistant information, an application identifier, a data network name, or a combination thereof.

7. The UE of claim 6, wherein the model training logical function provisions local models to the local model training logical functions to initiate local training.

8. The UE of claim 7, wherein the local model training logical function trains the local model with data collected from local data producer network function and provides model parameters related to the trained local model to the model training logical function.

9. A first network function, comprising:
at least one memory; and
at least one processor coupled with the at least one memory and configured to cause the first network function to:
receive a first request from a second network function, wherein the first request comprises first requirements to provide a trained model, the first requirements comprise an analytics identifier identifying a model and requirements to provide the trained model for a specific area of interest, a public land mobile network identifier, a data network access identifier, a single network slice selection assistant information identifier, an application identifier, a data network name identifier, or a combination thereof;
determine that the first request uses federated learning to train the model corresponding to the first requirements;
determine a network function that supports model aggregation using federated learning;
transmit a second request to a third network function supporting model training using federated learning, wherein the second request comprises a request to provide a trained model using federated learning based on the first requirements; and
, in response to transmitting the second request, receive aggregated model parameters, train the model using the aggregated model parameters to result in a trained model, transmit a first response to the first request, and the response comprises information indicating that the trained model is available.

10. The first network function of claim 9, wherein the at least one processor is configured to cause the first network function to determine that the first request uses federated learning to train the model corresponding to the first requirements by receiving a second response from a data producer network function, the second response is received in response to a request for data collection, and the second response indicates that data is unavailable.

11. The first network function of claim 9, wherein the at least one processor is configured to cause the first network function to determine that the first request uses federated learning to train the model corresponding to the first requirements by determining that data is to be collected from at least one data producer network function to train the model is not available.

12. The first network function of claim 9, wherein the at least one processor is configured to cause the first network function to determine that the first request uses federated learning to train the model is based on the first requirements.

13. A second network function, comprising:
at least one memory; and
at least one processor coupled with the at least one memory and configured to cause the second network function to:
receive a first request comprising first requirements to provide an analytics report, wherein the first requirements comprise an analytics identifier identifying a model and requirements to provide a trained model for a specific area of interest, a public land mobile network, a data network access identifier, a single network slice selection assistant information, an application identifier, a data network name, or a combination thereof;
determine that the trained model uses federated learning; and
transmit a second request to a first network function, wherein the second request comprises first requirements to derive the trained model; wherein the receiver receives a response to the second request,
wherein the response comprises information indicating that the trained model is available.

14. The second network function of claim 13, wherein the at least one processor is configured to cause the second network function to determine that the first request uses federated learning to train the model corresponding to the first requirements by determining that data is required to be collected from at least one data producer network function to train the model is not available.

15. The second network function of claim 13, wherein at least one processor is configured to cause the second network function to determine that the first request uses federated learning to train the model is based on the first requirements.

16. A processor for wireless communication, comprising:
at least one controller coupled with at least one memory and configured to cause the processor to:
receive a first request from a network function, wherein the first request comprises first requirements to provide a trained model;
determine model parameters for aggregation using federated learning based on the first requirements in the first request;
discover at least one local model training logical function that can provide model parameters for aggregation using federated learning based on the first requirements;
transmit a second request to the at least one local model training logical function to receive the model parameters for deriving the aggregated trained model; and
aggregate the model parameters using federated learning, transmit a response to the first request, and the response comprises the aggregated model parameters.

17. The processor of claim 16, wherein the at least one local model training logical function comprises at least one network function or at least one application function.

18. The processor of claim 17, wherein the network function comprises an analytics logical function, a model training logical function, or a combination thereof.

19. The processor of claim 18, wherein the first requirements to derive the aggregated training model using federated learning comprises an analytics identifier identifying a model, identifiers corresponding to the data that cannot be collected, a specific area of interest, a public land mobile network identifier, a data network access identifier, a single network slice selection assistant information identifier, an application identifier, a data network name identifier, or a combination thereof.

20. The processor of claim 19, wherein the at least one controller is configure to cause the processor to discover at least one local model training logical function to retrieve model parameters for federated learning from a network repository function.
